(19) United States
(12) Patent Application Publication
(10) Pub. No.: US 2026/0048859 A1
(43) Pub. Date: Feb. 19, 2026

(54) METHODS AND APPARATUS FOR DETERMINANT ASSEMBLY SUPPORT

(71) Applicant: The Boeing Company, Arlington, VA (US)

(72) Inventor: Chester James Hill, IV, Grafton, IL (US)

(21) Appl. No.: 18/806,145

(22) Filed: Aug. 15, 2024

(51) Int. Cl. B64F 5/10

(52) U.S. Cl. CPC B64F 5/10

(57) ABSTRACT

Methods and apparatus for determinant assembly support are disclosed. A disclosed apparatus to orient, locate and support a panel component for assembly thereof includes a ball extending from an arm of a support frame for carrying the panel component, and a socket having a conical portion to receive the ball to couple the support frame to an assembly jig, the socket including a slot on at least one sidewall thereof to enable a clearance of the socket to the arm of the support frame.

### FIELD OF THE DISCLOSURE

This disclosure relates generally to tooling/manufacturing and, more particularly, to methods and apparatus for determinant assembly support.

### BACKGROUND

For aircraft applications, parts and/or components can have a significant weight, as well as size. For example, aircraft panels, such as those utilized in fuselage or wing sections, can be relatively large such that portions thereof can displace relative to another based on a weight distribution and a manner in which the panels are handled and/or constrained. In particular, known methods can necessitate a challenging precision hoist. Weight, size, require precise location and foster challenging hoist operations with respect to initial part location.

### SUMMARY

An example apparatus to orient, locate and support a panel component for assembly thereof includes a ball extending from an arm of a support frame for carrying the panel component, and a socket having a conical portion to receive the ball to couple the support frame to an assembly jig, the socket including a slot on at least one sidewall thereof to enable a clearance of the socket to the arm of the support frame.

An example socket of a support jig to be rotatably coupled to a frame support for a vehicle frame component includes a base, and a conical portion extending from the base, a conical surface of the conical portion converging toward the base, the conical surface for contacting and guiding a ball pin of a support frame, the conical surface at least partially defined by a sidewall having a slot for clearance of a portion of the ball pin.

An example method of coupling a support frame for carrying an aircraft panel component to a support jig includes placing a ball extending from an arm of the support frame to a conical portion of a socket of the support jig, the placement of the ball to the conical portion to rotationally couple the support frame to the support jig, and moving the support frame to contact a stop of the support jig in response to the support frame being rotationally coupled to the support jig.

### BRIEF DESCRIPTION OF THE DRAWINGS

FIG. 1 illustrates an example aircraft in which examples disclosed herein can be utilized for the manufacture thereof.

FIG. 2 illustrates an example manufacturing assembly in which examples disclosed herein can be implemented.

FIG. 3 illustrates a support frame of the example manufacturing assembly of FIG. 2 in a hoisting position.

FIGS. 4A and 4B are detailed views of the example manufacturing assembly of FIGS. 2 and 3.

FIG. 5 is a detailed cross-sectional view of a joint of the example manufacturing assembly of FIGS. 2-4B.

FIGS. 6A and 6B depict example sockets that can be implemented in examples disclosed herein.

FIG. 7 is a flowchart representative of an example method in accordance with teachings of this disclosure.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Methods and apparatus for determinant assembly support are disclosed. In manufacturing environments, handling of a relatively large component in combination with its weight distribution can cause the component to warp and/or displace under the influence of gravity. For example, an aircraft fuselage panel can bend, warp and/or twist based on a distribution of weight over a relatively large distance. As a result, the panel can misalign to another component, such as a frame component and/or assembly. In turn, features of the panel can be difficult to align with corresponding features of the other component and, thus, assembly and/or handling thereof can be difficult. As a result, the component may necessitate reworking or may be rejected, thereby resulting in an increased repair and/or rework time, for example.

Examples disclosed herein are effective in mitigating the effects of gravity or other forces imparted on relatively large components such as skin panels, for example. Examples disclosed can enable more efficient and time-saving assembly of components by mitigating the effects of gravity or other forces that can adversely impact assembly of relatively large components. Examples disclosed herein can also reduce a need for setting up and/or updating tooling indexes by mitigating tolerance issues of relatively large components. While examples disclosed herein are described in the context of aircraft, examples disclosed herein can be applied to any other appropriate type of assembly and/or structure that is stationary or movable.

Examples disclosed herein support a frame (e.g., a support frame) that is releasably and/or rotatably couplable to a support jig/fixture (e.g., an assembly jig, a manufacturing jig, etc.) corresponding to a determinant assembly process. Examples disclosed herein utilize multiple holding devices, such as clamps, to carry and/or support a panel component (e.g., a vehicle panel, an aircraft panel, a fuselage panel, etc.). While the examples herein describe support of a panel component such as a skin panel, for example, it should be understood that the panel component may be an elongate workpiece, plate or other structure. According to some examples disclosed herein, multiple clamps are utilized to couple the panel component to the support frame, thereby reducing forces and/or distortions imparted to the panel component (e.g., forces due to gravity) while the panel component is being supported by the support frame. As a result, the part can be distorted and/or warped to an extent that can make it difficult to assemble other components thereto.

According to examples disclosed herein, the support frame is operatively and/or rotatably coupled to the aforementioned jig with a rotational joint. According to some examples disclosed herein, the support frame is rotationally coupled to the aforementioned assembly jig such that the support frame can be rotated relative to the assembly jig when coupled thereto. In some such examples, the support frame may be rotated until stops of the support frame contact a portion of the assembly jig and prevent further rotation of the support frame. Additionally or alternatively, the support frame may rotate under the influence of gravity until the stops of the support frame contact the portion of the assembly jig.

According to examples disclosed herein, the support frame and the assembly jig define a ball and socket joint therebetween. In an example, a socket of the assembly jig includes a conical portion and/or section to receive a ball or other round object extending from the support frame. According to examples disclosed herein, the socket, which is generally conical in shape, includes a slot on a sidewall thereof to enable movement of the support frame relative to the assembly jig. In particular, the slot can at least partially define a clearance to an arm/stem supporting the ball of the support frame. Additionally or alternatively, the slot can be utilized to guide the arm (e.g., in conjunction with guidance provided to the ball via the conical portion). In some examples, the slot includes a lead-in chamfer, a draft and/or a V-shaped contour cutout for guidance of the support frame with respect to the assembly jig.

As used herein, the terms “slotted,” “slotted opening” or “a slotted interface” refer to a fit in which a first component has a relatively large clearance relative to a second component such that the second component can move, rotate and/or translate relative to the first component. As used herein, the term “frame” can refer to any understructure, superstructure, side-supportive structure or a variation thereof utilized to support an object, structure and/or component.

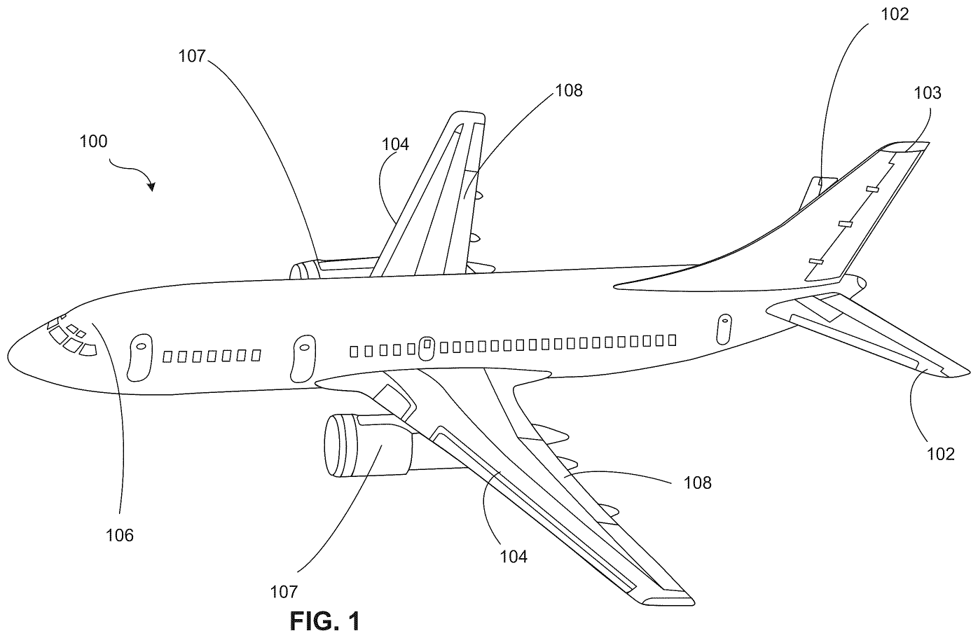

FIG. 1 illustrates an example aircraft 100 in which examples disclosed herein can be implemented. In particular, examples disclosed herein can be utilized to produce components and/or parts associated with the aircraft 100 and the subassemblies therein, for example. In the illustrated example of FIG. 1, the aircraft 100 includes horizontal tails 102, a vertical tail 103 and wings (e.g., fixed wings) 104 attached to a fuselage 106. The wings 104 of the illustrated example have engines 107, and control surfaces (e.g., flaps, ailerons, tabs, etc.) 108, some of which are located at a trailing edge or a leading edge of the wings 104. The control surfaces 108 may be displaced or adjusted (e.g., deflected, etc.) to provide lift during takeoff, landing and/or flight maneuvers.

In the illustrated example of FIG. 1, internal components and/or assemblies are located in the fuselage 106 (and other external components) of the aircraft 100. Examples disclosed herein can be applied to any appropriate internal or external structure and/or vehicle. Accordingly, examples disclosed herein can be utilized for rotorcraft, spacecraft, watercraft, submersibles, unmanned aerial vehicles, or stationary structures, etc. Examples disclosed herein can be utilized for any appropriate structure that can be adversely affected by gravity and/or distortions caused by gravity, for example. In a particular scenario, examples disclosed herein can effectively support a panel of the fuselage 106 and can reduce warpage and/or distortion thereof to facilitate assembly of frame components thereto. Examples disclosed herein can be applied to any of the horizontal tails 102, the vertical tail 103, the wings (e.g., fixed wings) 104, the fuselage 106, the engines 107, and the control surfaces (e.g., flaps, ailerons, tabs, etc.) 108 (or any other appropriate component of the aircraft 100).

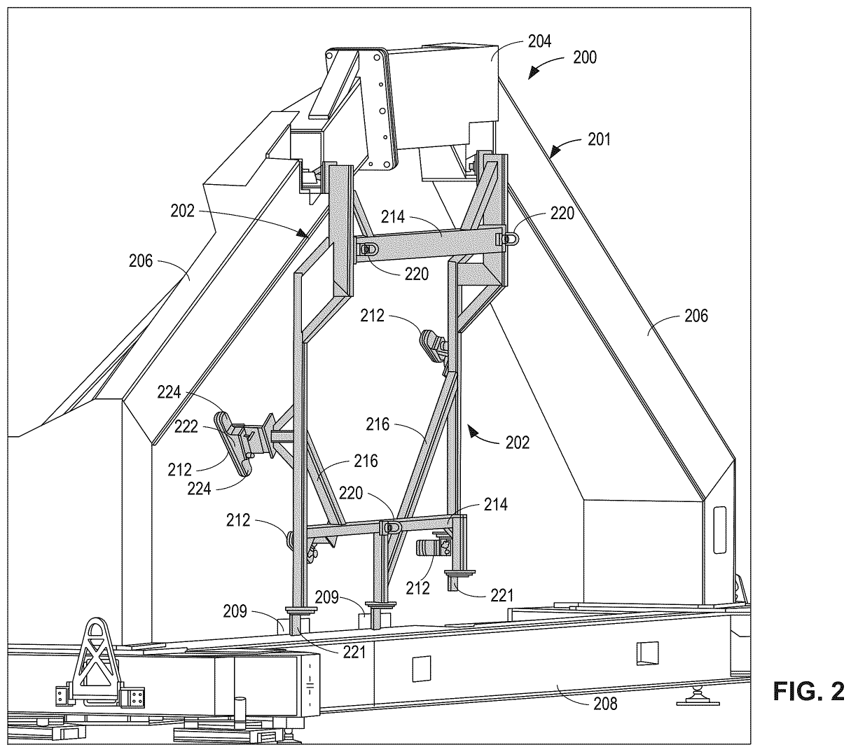

FIG. 2 illustrates an example manufacturing assembly 200 in which examples disclosed herein can be implemented. In particular, the example manufacturing assembly 200 is utilized to support an aircraft panel (e.g., a vehicle panel, an internal panel, an external panel, an aircraft skin, an aircraft fuselage panel, an exterior vehicle surface, a wing panel, a wing surface, a skin panel, an external panel, etc.) and to aid in supporting the panel during assembly of individual frame sections of a frame structure of the aircraft 100 shown in FIG. 1. According to examples disclosed herein, the panel can include a surface body (e.g., a curved planar body, a relatively flat planar body, etc.) with apertures for fastening subcomponents thereto.

In the illustrated example of FIG. 2, the example manufacturing assembly 200 includes an assembly jig (e.g., an assembly super structure, etc.) 201 and a frame support 202. The example assembly jig 201 includes a cross-brace 204, side supports 206 and a horizontal base 208 supporting tabs (e.g., stopping tabs) 209. The example manufacturing assembly 200 further includes a support frame 202 with holders (e.g., holding devices, clamps, clamping devices, etc.) 212, lateral beams 214, angled beams 216, retention hooks 220 and tabs 221. The example holders 212 are implemented as clamps (e.g., clamping elements) in this example and herein referred to as clamps. In this example, the clamps 212 include a body (e.g., a main body, a central body, a central portion, etc.) 222 with corresponding tabs 224 extending laterally therefrom.

According to examples disclosed herein, to secure the panel to the support frame 202, the aforementioned tabs 224 can include apertures extending therethrough. In particular, a fastener (e.g., a pin, a locking pin, a hand knob, a clevis pin, a screw, a bolt, a nut, an insert, etc.) is placed through respective ones of the apertures of the tabs 224 to secure the panel to the support frame 202. In this example, the apertures of the tabs 224 in conjunction with fastener to form a relatively tight nominal fit that enables a relatively precise part location. In this example, the clamps 212 include clamping portions/bodies that may be placed on opposite sides (e.g., opposite surfaces, interior and exterior surface, etc.) of the panel.

To prevent distortion of the panel, which can result in increased difficulty for assembly of subcomponents, at least one of the clamps 212 is enabled to move and/or displace via a slotted and/or oversized clearance interface. According to examples disclosed herein, the clamps 212 are arranged in opposing pairs such that each of the opposing pairs support a portion of the panel.

In this example, the example support frame 202 is placed into the aforementioned assembly jig 201 such that the support frame 202 is rotationally coupled to the jig 201, thereby defining a rotational joint therebetween. In particular, the support frame 202 carrying the panel can be lifted over to the jig 201 such that the support frame 202 is able to rotate about the rotational joint until the stops 221 contact a surface, feature and/or component of the jig 201. In some such examples, the support frame 202 can rotate under the influence of gravity until the stops 221 contact the supporting tabs (e.g., supporting stops) 209 of the jig 201 and the panel is in a position and/or orientation (e.g., rotational orientation) such that forces imparted thereto are reduced and/or minimized. In other words, the panel can be rotated via gravity upon the support frame 202 being rotationally coupled to the jig 201. Once the panel is secured to the support frame 202 and the hoisted support frame 202 is coupled to the assembly jig 201 so that the assembly jig 201 bears the weight of the support frame 202, the panel may be assembled relative to a vehicle frame structure without the weight of the attached support frame 202 imparting load to the panel or causing distortion in the panel. As mentioned above, according to examples disclosed herein, individual components such as individual frame sections of a vehicle frame structure can be assembled to a panel (and to one another) when the panel and the support frame 202 are supported by the assembly jig 201. For example, vehicle frame sections and components can be assembled to the panel. As previously indicated, the weight of a completely assembled frame structure may induce distortion or deflection across the length of frame sections such that apertures in the frame structure may no longer align with apertures in the panel, which could cause binding when attempting to install fasteners.

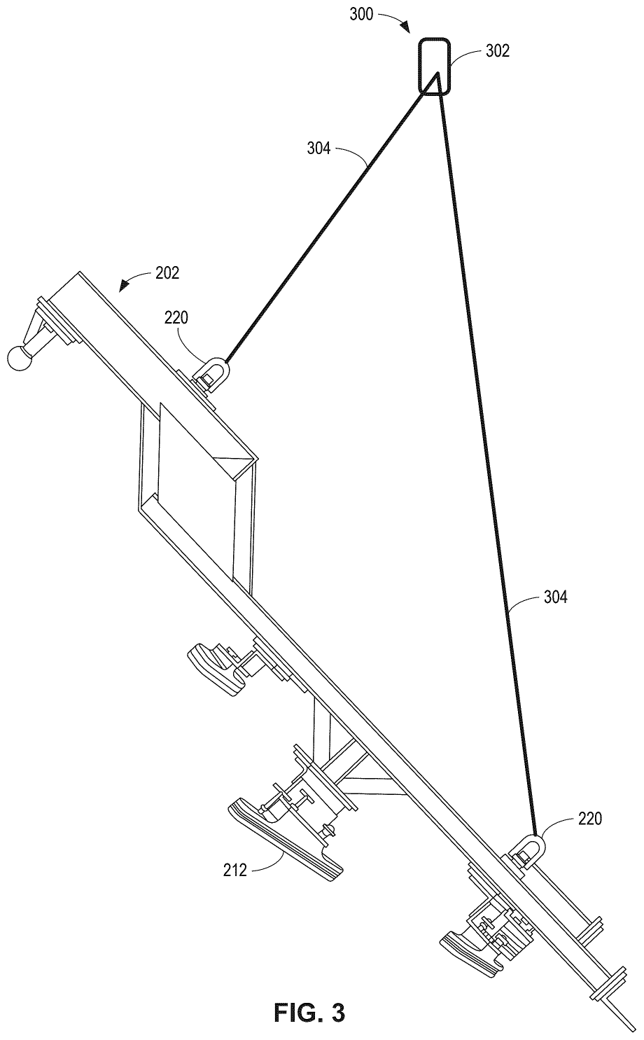

FIG. 3 illustrates the support frame 202 of the example manufacturing assembly 200 in a hoisting position. In this example, a side view of the support frame 202 is shown. According to examples disclosed herein, the support frame 202 is supported by a hoist (e.g., hoist equipment) 300 which, in turn includes a hub 302 and at least one cable 304. In this example, the hooks 220 in combination with the at least one cable 304 are utilized to support the support frame 202 at an angle from the ground. According to some examples disclosed herein, the support frame 202 and the panel (not shown) secured via the clamps 212) is oriented at approximately 40 degrees (°) to 50° (e.g., 45°) from the ground. As a result, the support frame 202 along with the panel can be lowered into the jig 201 shown in FIG. 2.

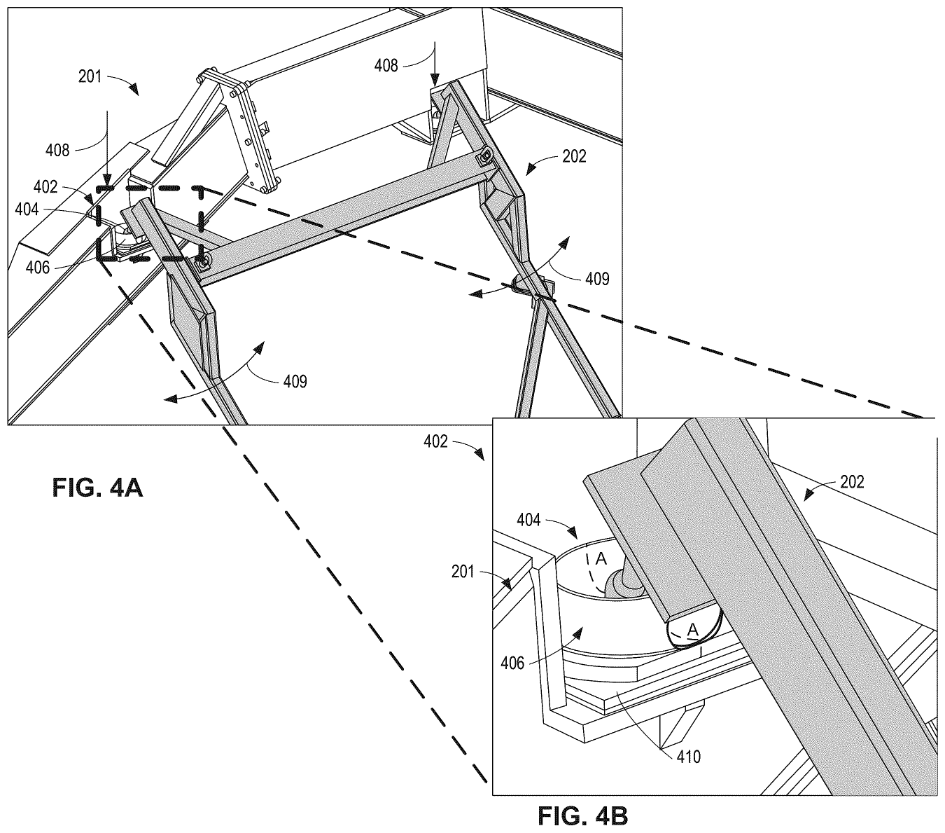

FIGS. 4A and 4B are detailed views of the example manufacturing assembly of FIGS. 2 and 3. Turning to FIG. 4A, a joint (e.g., a rotational joint) 402 that the rotationally couples the support frame 202 to the jig 201 is shown. In this example, the support frame 202 includes a ball (e.g., a ball pin, etc.) 404 extending therefrom and the jig 201 includes, carries and/or supports a socket 406.

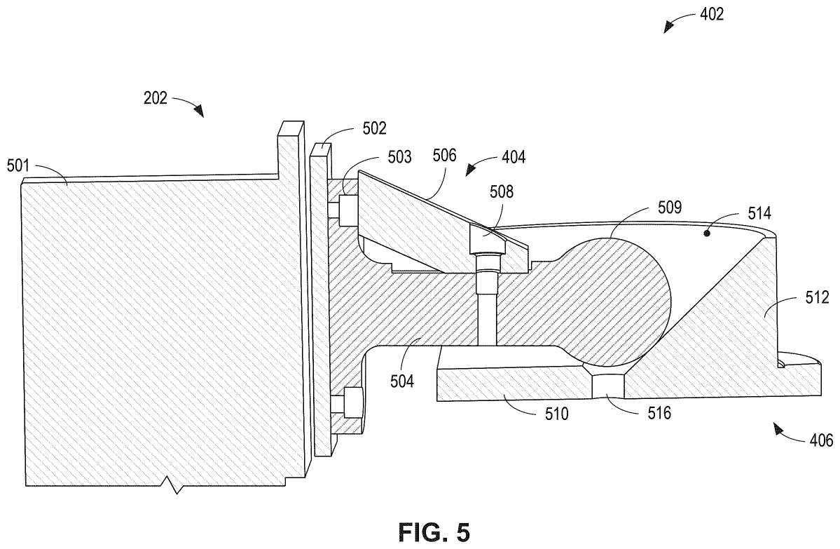

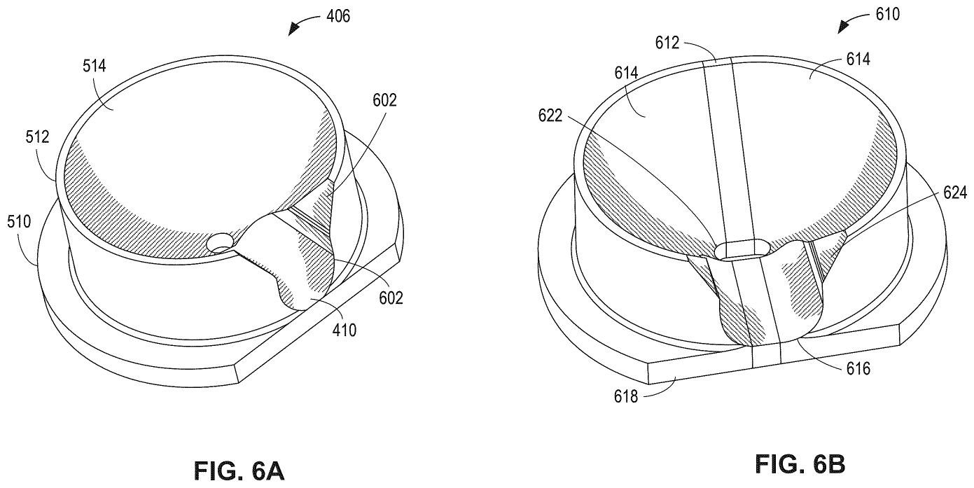

According to examples disclosed herein, to rotationally couple the support frame 202 to the jig 201, the support frame 202 is carried by a hoist (e.g., a hoist system) and lowered into the jig 201, as generally indicated by an arrow 408. According to examples disclosed herein, as will be shown below in connection with FIGS. 4B and 5, the ball 404 extending from the support frame 202 is inserted into and/or placed onto the socket 406 of the jig 201 as the support frame 202 is lowered. As shown and described below in connection with FIG. 6A, the example socket 406 includes a conical portion, surface and/or section that converges toward a bottom/downward direction (in the view of FIG. 4A). In particular, the conical portion and/or section can guide the corresponding ball 404 as the support frame 202 is lowered. As a result of the ball 404 engaging the conical portion, the support frame 202 can rotate in directions generally indicated by double arrows 409. In this example, two of the balls 404 are arranged laterally across a span of the support frame 202. However, any other appropriate number of the balls 404 can be implemented instead.

FIG. 4B is a detailed view of the ball 404 engaging the socket 406. As can be seen in FIG. 4B, a slot 410 of the socket 406 enables a sufficient clearance between the socket 406 and the ball 404 (and related structures/components to the ball 406) to enable rotation of the support frame 202 relative to the jig 201. Further, the slot 410 can also act as an alignment and/or guiding feature to guide (downward) lateral positioning of the support frame 202 with respect to the jig 201.

FIG. 5 is a detailed cross-sectional view of the rotational joint 402 of the example manufacturing assembly 200 of FIGS. 2-4B. The cross-sectional view of FIG. 5 is taken along a plane A-A indicated in FIG. 4B. In the illustrated example of FIG. 5, a wall/base 501 of the support frame 202 is shown supporting the ball 404, which is engaged to the socket 406.

The example ball 404 includes a base 502, an aperture (e.g., a coupling aperture) 503, an arm (e.g., a stem) 504, a stiffener (e.g., an angled stiffener) 506, and an aperture (e.g., a coupling aperture) 508 for coupling the stiffener 506 to the arm 504. The example socket 406 includes a base 510, a sidewall 512, a conical portion 514 and an aperture 516 extending through a portion of the aforementioned base 510. In this example, the aperture 516 is centered on a conical geometry of the conical portion of the conical portion 514.

To guide the ball end 509 with respect to the conical portion 514 of the socket 406, an outer surface of the ball end 509 slides against a corresponding surface (e.g., conical surface) of the conical portion 514, thereby guiding a motion of the ball end 509 and, thus, the support frame 202. Accordingly, gravity acting upon the support frame 202 causes the ball end 509 to move toward and reach the aperture 516, which acts as a relief and/or guide for the ball end 509 in this example. In some examples, the aperture 516 can at least receive a portion of the ball end 509.

In some examples, the conical portion has a cone angle of approximately 35-55 degrees (e.g., 45 degrees). In some examples, the ball 404 and/or the ball end 509 is at least partially composed of steel (e.g., a case hardened steel), aluminum, etc. However, any other appropriate material and/or alloy can be implemented instead. In this example, a ratio of a diameter of a maximum diameter of the conical section 514 to the ball end 509 is greater than 2.0. However, any other appropriate ratio can be implemented instead.

FIGS. 6A and 6B depict example socket implementations that can be implemented in examples disclosed herein. Turning to FIG. 6A, the aforementioned socket 406 of FIGS. 4A-5 is shown. As can be seen in the illustrated example, the conical portion 514 at least partially defines the sidewall 512 that extends from the base 510. Further, the slot 410 is depicted having a chamfer (e.g., a lead-in chamfer) 602 at a longitudinally distal end of the socket 406. In this example, the chamfer is generally V-shaped. However, the chamfer 602 can be any other appropriate shape.

FIG. 6B is alternative example socket 610 that can be implemented in examples disclosed herein. In contrast to the example socket 406, the socket 610 of the illustrated example includes an elongate center portion (e.g., an elongate medial portion, etc.) 612 that separates and/or divides conical portions (e.g., conical surface portions, conical halves, etc.) 614. Further, the elongate center portion 612 defines a U-shaped slot 616 that extends from a base 618, as well as a slotted aperture 622, in contrast to a circular aperture. The slotted aperture 622 can be particularly advantageous in accommodating tolerance mismatch and/or alignment issues. In some examples, a chamfer 624 is defined on the distal end of the socket 610.

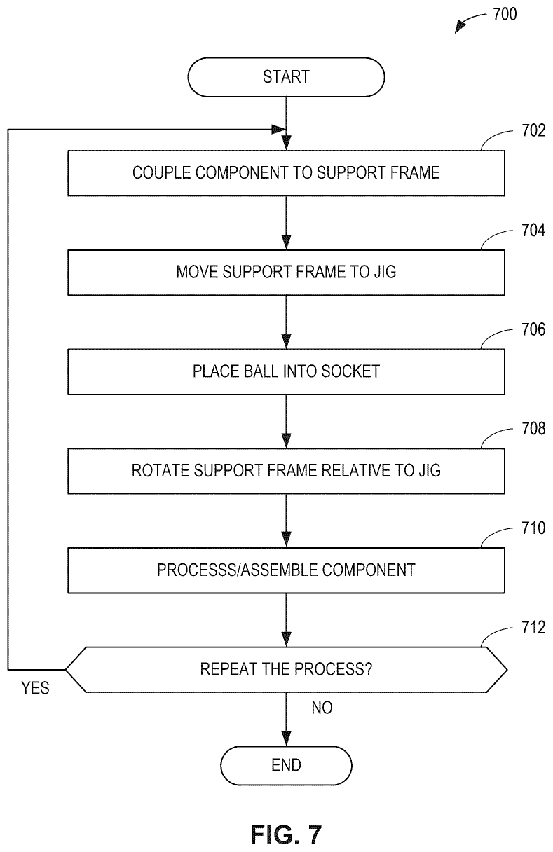

FIG. 7 is a flowchart representative of an example method 700 in accordance with teachings of this disclosure. The example method 700 is utilized for supporting a panel during a manufacturing process and begins as a component, which is a vehicle panel (e.g., a fuselage panel for an aircraft, an aircraft panel, an aircraft skin surface, etc.,) in this example, is to be supported for assembly of subcomponents (e.g., frame subcomponents) thereto. At block 702, an example panel component/workpiece is coupled to and/or placed on a support frame (e.g., the support frame 202) via clamps (e.g., the clamps 212). In this example, at least one pair of opposing clamps is utilized to carry and/or support the vehicle panel with a compressible material.

At block 704, according to examples disclosed herein, the support frame is coupled to an assembly jig (e.g., the jig 201). In this example, the support frame is rotationally coupled to the assembly jig.

At block 706, a ball (e.g., a ball end, a ball pin, etc.) of the support frame is placed into a socket of the jig. In the illustrated example, the ball is inserted into a conical section of the socket and the ball is guided with respect to the conical section to align the support frame relative to the assembly jig. In this example, two of the balls are utilized such that the balls are laterally spaced across the support frame.

At block 708, in some examples, the support frame is rotated, moved and/or oriented once coupled to the assembly jig. For example, the support frame can be rotated under the influence of gravity until a surface and/or portion of the support frame contacts another surface to prevent further rotational motion of the support frame.

At block 710, additional frame section components and/or sub-frame components are assembled to the vehicle panel. In this example, frame sections and components are assembled to the vehicle panel, as well as other frame components.

At block 712, it is determined whether to repeat the process. If the process is to be repeated (block 712), control of the process returns to block 702. Otherwise, the process ends. This determination may be based on whether additional panels are to be assembled with components and/or subcomponents.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

Example methods, apparatus, systems, and articles of manufacture to facilitate determinant assembly of gravitationally compromised structures are disclosed herein. Further examples and combinations thereof include the following:

Example 1 includes an apparatus to support a panel component for assembly thereof, the apparatus comprising a ball extending from an arm of a support frame for carrying the panel component, and a socket having a conical portion to receive the ball to couple the support frame to an assembly jig, the socket including a slot on at least one sidewall thereof to enable a clearance of the socket to the arm of the support frame.

Example 2 includes the apparatus as defined in example 1, wherein the slot includes a chamfer at a distal end thereof.

Example 3 includes the apparatus as defined in any of examples 1 or 2, wherein the conical portion converges to an aperture at a base of the socket from which the conical portion extends.

Example 4 includes the apparatus as defined in any of examples 1 to 3, wherein the slot is an elongated slot defining a relatively flat medial portion of the conical portion.

Example 5 includes the apparatus as defined in any of examples 1 to 4, wherein a conical surface of the socket has a cone angle of approximately 35-55 degrees.

Example 6 includes the apparatus as defined in any of examples 1 to 5, further including an angled support brace to support the arm.

Example 7 includes the apparatus as defined in any of examples 1 to 6, wherein the ball is a first ball, the socket is a first socket and the conical portion is a first conical portion, and further including a second ball of the support frame, and a second socket of the jig, the second socket having a second conical surface to receive the second ball.

Example 8 includes the apparatus as defined in example 7, wherein the first socket and the second socket are laterally spaced apart from one another.

Example 9 includes a socket of a support jig to be rotatably coupled to a frame support for a vehicle frame component, the socket comprising a base, and a conical portion extending from the base, a conical surface of the conical portion converging toward the base, the conical surface for contacting and guiding a ball pin of a support frame, the conical surface at least partially defined by a sidewall having a slot for clearance of a portion of the ball pin.

Example 10 includes the socket as defined in example 9, further including an aperture at a base of the conical portion, the aperture to receive a portion of the ball pin.

Example 11 includes the socket as defined in any of examples 9 or 10, further including an elongate medial portion.

Example 12 includes the socket as defined in example 11, wherein the elongate medial portion defines a slotted opening of the base.

Example 13 includes the socket as defined in any of examples 11 or 12, wherein the slot of the sidewall is generally U-shaped.

Example 14 includes the socket as defined in any of examples 9 to 13, wherein the conical surface of the socket has a cone angle of approximately 35-55 degrees.

Example 15 includes the socket as defined in any of examples 9 to 14, wherein the slot of the sidewall includes a lead-in chamfer.

Example 16 includes the socket as defined in any of examples 9 to 15, wherein the socket is at least partially composed of case hardened steel.

Example 17 includes a method of coupling a support frame for carrying an aircraft panel component to a support jig, the method comprising placing a ball extending from an arm of the support frame to a conical portion of a socket of the support jig, the placement of the ball to the conical portion to rotationally couple the support frame to the support jig, and moving the support frame to contact a stop of the support jig in response to the support frame being rotationally coupled to the support jig.

Example 18 includes the method as defined in example 17, wherein moving the support frame includes rotating the support frame about an interface between the ball and socket until the support frame contacts the stop.

Example 19 includes the method as defined in example 18, wherein the support frame is rotated to contact the stop due to the influence of gravity.

Example 20 includes the method as defined in any of examples 17 to 19, wherein the support frame is aligned relative to the support jig as the ball contacts and moves along a conical surface of the conical portion.

From the foregoing, it will be appreciated that example systems, apparatus, articles of manufacture, and methods have been disclosed that enable relatively quick and effective assembly of components that can otherwise be difficult to assemble.

Examples disclosed herein can mitigate the effects of gravity or other forces on relatively large and/or heavy components that can be subject to bending and warpage, which can increase a difficulty of assembly of other components thereto. Examples disclosed herein can also reduce manufacturing time as well as rejected components and/or reworking typically associated with conventional manufacturing techniques.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to support a panel component for assembly thereof, the apparatus comprising:
a ball extending from an arm of a support frame for carrying the panel component; and
a socket having a conical portion to receive the ball to couple the support frame to an assembly jig, the socket including a slot on at least one sidewall thereof to enable a clearance of the socket to the arm of the support frame.

2. The apparatus as defined in claim 1, wherein the slot includes a chamfer at a distal end thereof.

3. The apparatus as defined in claim 1, wherein the conical portion converges to an aperture at a base of the socket from which the conical portion extends.

4. The apparatus as defined in claim 1, wherein the slot is an elongated slot defining a relatively flat medial portion of the conical portion.

5. The apparatus as defined in claim 1, wherein a conical surface of the socket has a cone angle of approximately 35-55 degrees.

6. The apparatus as defined in claim 1, further including an angled support brace to support the arm.

7. The apparatus as defined in claim 1, wherein the ball is a first ball, the socket is a first socket and the conical portion is a first conical portion, and further including:
a second ball of the support frame, and
a second socket of the jig, the second socket having a second conical surface to receive the second ball.

8. The apparatus as defined in claim 7, wherein the first socket and the second socket are laterally spaced apart from one another.

9. A socket of a support jig to be rotatably coupled to a frame support for a vehicle frame component, the socket comprising:
a base; and
a conical portion extending from the base, a conical surface of the conical portion converging toward the base, the conical surface for contacting and guiding a ball pin of a support frame, the conical surface at least partially defined by a sidewall having a slot for clearance of a portion of the ball pin.

10. The socket as defined in claim 9, further including an aperture at a base of the conical portion, the aperture to receive a portion of the ball pin.

11. The socket as defined in claim 9, further including an elongate medial portion.

12. The socket as defined in claim 11, wherein the elongate medial portion defines a slotted opening of the base.

13. The socket as defined in claim 11, wherein the slot of the sidewall is generally U-shaped.

14. The socket as defined in claim 9, wherein the conical surface of the socket has a cone angle of approximately 35-55 degrees.

15. The socket as defined in claim 9, wherein the slot of the sidewall includes a lead-in chamfer.

16. The socket as defined in claim 9, wherein the socket is at least partially composed of case hardened steel.

17. A method of coupling a support frame for carrying an aircraft panel component to a support jig, the method comprising:
placing a ball extending from an arm of the support frame to a conical portion of a socket of the support jig, the placement of the ball to the conical portion to rotationally couple the support frame to the support jig; and
moving the support frame to contact a stop of the support jig in response to the support frame being rotationally coupled to the support jig.

18. The method as defined in claim 17, wherein moving the support frame includes rotating the support frame about an interface between the ball and socket until the support frame contacts the stop.

19. The method as defined in claim 18, wherein the support frame is rotated to contact the stop due to the influence of gravity.

20. The method as defined in claim 17, wherein the support frame is aligned relative to the support jig as the ball contacts and moves along a conical surface of the conical portion.
